(19) United States
(12) Patent Application Publication
(10) Pub. No.: US 2020/0410416 A1
(43) Pub. Date: Dec. 31, 2020

(54) METHOD FOR SCHEDULING OR CONTROLLING THE MOVEMENTS OF A PLURALITY OF VEHICLES OVER A NETWORK OF ROUTES

(71) Applicant: DEUTSCHE BAHN AG, Berlin (DE)

(72) Inventors: Daniel KINDLER, Sulzbach (Ts.) (DE); Karl SCHÖPF, Wiesbaden (DE); Kai GOTTHARDT, Bensheim (DE); Moritz VON BONIN, Berlin (DE); Michael KUPERBERG, Frankfurt am Main (DE); Sergiu-Matei BURCIU, Frankfurt am Main (DE)

(73) Assignee: DEUTSCHE BAHN AG, Berlin (DE)

(21) Appl. No.: 16/975,756

(22) PCT Filed: Mar. 20, 2019
(86) PCT No.: PCT/DE2019/100259

§ 371 Date: Aug. 26, 2020

(30) Foreign Application Priority Data
Mar. 23, 2018 (DE) 10 2018 204 509.7

(51) Int. Cl. G06Q 10/06; G06Q 30/02; H04L 9/32

(52) U.S. Cl. CPC G06Q 10/06311; G06Q 30/0284; H04L 2209/84; H04L 2209/38; H04L 9/3239

(57) ABSTRACT

A method for scheduling or controlling the movements of a plurality of vehicles over a network of routes is disclosed. The nodes and edges of the network of routes are formed by route elements. The control and management of route elements by a central authority is complex and susceptible to disturbances. The method enables a simplification of the technical infrastructure that is to be maintained within the network and improves its availability and thus also the resistance of the network to technical disruptions. This is achieved in that any vehicle as an entity represented in a distributed ledger system enters into transaction agreements with the route elements, likewise represented as entities in this distributed ledger system, wherein each transaction agreement of a vehicle with a route element includes at least one time specification, which defines the period of time for which the route element is occupied by the vehicle.

The invention relates to a method for scheduling or controlling the movements of a plurality of vehicles over a network of routes, the nodes and edges of which are formed by route elements.

According to the current state of the art, the safety of rail-bound transport systems is based on a strictly regulated central system in which all elements of the track, such as points, stretches of track and signals, are controlled by a central authority in the form of a signal box and are assigned to individual train runs. For example, the release or permission to carry out a train run is only transmitted from the signal box to the respective vehicle when, in a first step, the availability of all field elements required for the train run has been determined by the signal box and, in a second step, these field elements have then been bindingly allocated and secured for the train run. Previous approaches to automation have been oriented towards, on the one hand, reducing the number of signal boxes and the number of employees required to operate them by enlarging the respective areas that they control. On the other hand, signalling by means of fixed signals is increasingly being replaced by signalling in the driver's cab of the vehicles, thus enabling further savings to be made by eliminating fixed infrastructure (in the form of signals and their cable connections). However, such a system is extremely sensitive to disturbances, which are either introduced into the system from outside or which may occur due to internal faults in the system itself. For example, even a relatively minor cause, such as a points tongue that is blocked by a lump of ice that has fallen from a train, can lead to all train runs that are to be handled by this set of points first being blocked for the duration of the disturbance condition and having to be rescheduled by manual intervention of personnel in the central authority of the locally responsible signal box. Although there are numerous approaches for automating and speeding up the rescheduling process using software-supported algorithms for automated conflict detection and avoidance of route conflicts, it is not possible completely to eliminate the delays in the operating process that this causes. An interruption of the communication links between the signal box and a field element or even the complete failure of a signal box itself have even greater effects.

The object of the invention is therefore to provide a method for scheduling or controlling the movements of a plurality of vehicles over a network of routes, the nodes and edges of which are formed by route elements, which enables a simplification of the technical infrastructure that is to be maintained within the network and its availability and thus also improves the resistance of the network to technical disturbances.

According to the invention, this object is achieved in that, in combination with the preamble of claim 1, each vehicle, represented as an entity in a distributed ledger system, enters into transaction agreements with the route elements, likewise represented as entities in said distributed ledger system, wherein each transaction agreement of a vehicle with a route element comprises at least one time specification, which defines the period of time for which the route element is occupied by the vehicle. In this way, the current status of all route elements is transparent and known to all participants in the distributed ledger system, subsequent manipulation or change of this status by the participants not being possible. Distributed ledger systems are known per se from the state of the art. The core idea of the invention is that, according to the method of the invention, each vehicle negotiates movement authorisations for predicted points in time in the direct contact with the individual route elements along the movement route that has been predicted and pre-planned by the respective vehicle within the network of routes. The essential criterion for the conclusion of such a transaction agreement is the availability of the respective route element, free from competing agreements by other vehicles or blocking by disturbances. The elimination of a central authority as intermediary between vehicle and route element which is made possible in this way significantly increases the availability of the scheduling or control method. This results in a significant simplification for the dynamic scheduling and allocation of route elements to vehicles that require their use for implementation of a planned route.

It is not only rail-bound traffic systems that may be the subject of such a scheduling or control method in accordance with the invention, but also other traffic systems, such as usage-regulated roads. Besides, usage-regulated parking spaces for vehicles, such as car parks, but also vehicle stopping points at gates, public transport stops and loading or unloading points in goods traffic may also be the subject of such a scheduling and control method according to the invention. Thus, by means of the scheduling and control method according to the invention, not only the movement of aerial vehicles on the apron between the runway and the check-in gate, but also the movement of forklift trucks between the different stations of a high bay warehouse may be scheduled and controlled. Furthermore, movements of aerial vehicles on predetermined flight paths may also be the subject of such a scheduling and control method according to the invention, provided that the flight path can be segmented into spatial elements. For this, the aerial vehicle books its planned flight movement on the flight path in advance (that is, before the start of use), the flight path consisting of a plurality of spatial elements represented as entities in a distributed ledger system at defined time points. In this way, the binding and collision-free occupancy or booking of flight paths for unmanned aerial vehicles e.g. drones is also possible. The scheduling and control method according to the invention may contribute to standardisation of traffic control in the transnational airspace. In the context of the invention, “vehicles” are to be regarded as any type of traffic or means of transport, regardless of whether they move on land, in water or in the air.

According to a particularly useful further development of the basic concept of the invention, it is provided that each transaction agreement of a vehicle with a route element comprises a further transaction criterion which designates a fee to be paid for the occupancy of the route element by the vehicle. In this way, driving or usage rights for route elements can be priced depending on other transaction conditions. Conceivable examples of applications for that could be, for example, that different charges are stipulated for the use of the same route element, e.g. depending on qualitative criteria for the provision of performance of the route. For example, a lower charge could be stipulated if a route element can only be used at a speed that is slower than the nominal speed or if at a defined point in time the demand for occupancy of a route element is only very weak. An important aspect of the invention is also that competing requests of different vehicles may be decided based on a monetary transaction criterion. For example, in a usage-regulated road system, the use of an accelerated lane, which is free of heavy goods traffic and slow road users, could be more highly priced than the use of a slower lane. Competing usage requests by different vehicles for the same route element may be regulated by concluding a transaction agreement as to the temporal order of their usage between two or more vehicles represented as entities.

One variant of the invention provides that the distributed ledger system is configured as a blockchain.

The invention further provides that the method comprises at least one transaction agreement of a first vehicle with a second vehicle concerning the exchange or release of a route element occupied by the first vehicle during a defined period of time. This means that once vehicles have occupied a route element using the method according to the invention, as entities represented in the same distributed ledger system they conclude transaction agreements among themselves, i.e. with other vehicles represented as entities in the distributed ledger system. In this manner, based on the scheduling and control method according to the invention, a subsequent exchange or trade of route elements that have been released for use is also possible directly between the vehicles, without the intervention of an intermediary.

It is therefore very meaningful for the transaction agreement of a first vehicle with a second vehicle concerning the exchange or release of a route element occupied by the first vehicle during a defined period of time to contain a further transaction criterion which designates a fee to be paid by the second vehicle for the exchange or release of the route element.

In the following, the present invention is explained in greater detail with reference to an exemplary embodiment.

The route elements of a rail route (i.e. the infrastructure elements necessary for the movement of the vehicles, such as tracks, points and signals), as well as their current status, are represented in a blockchain. Regarding the status, primarily it is recorded whether, by virtue of a transaction agreement, the route element is occupied by another vehicle for a certain period of time in the present or in the future. Disturbance conditions can be made available in the method according to the invention by means of a permanent occupancy by an independent entity. The blockchain thus contains not only the current statuses, but also the past occupancy statuses resulting from previous transactions, as well as transactions with effects on future occupancy statuses.

The rail vehicles are represented in the block chain by a key pair that comprises a private key and a public key. Transaction requests of the rail vehicles are signed with these keys. The private key enables the unique assignment of each transaction request to a rail vehicle.

To reduce the computational effort involved in the operation of the method according to the invention, the access to the blockchain is restricted according to the “proof of authority” method that is known per se.

For the reservation of a path necessary for a train run comprising the occupation of at least one route element, the rail vehicle sends a transaction request comprising several transaction parameters (such as the place of departure, the earliest possible departure time, the destination and the latest possible arrival time) to a—distributed ledger—system, which searches the stored transactions for possible movement routes and transmits all possible variants back to the rail vehicle. The transaction parameters transmitted back to the rail vehicle may include the price of using the various route elements as an additional transaction criterion.

By means of an algorithm implemented in the control computer of the rail vehicle, a selection is made from the plurality of route alternatives and the movement is started. However, the method according to the invention may of course also provide for additional manual confirmation by human operators as a prerequisite for starting the vehicle movement. While the absence of conflicts in the allocation of the route elements is guaranteed by the consistency of the transaction agreements in the distributed ledger system, additional safety of each movement that takes place via the route elements of the rail route (e.g. against train runs that approach too close or cross) may follow from the conventional safety systems of the rail route (e.g. stationary signals).

1.-5. (canceled)

6. A method for scheduling or controlling the movements of a plurality of vehicles over a network of routes, the nodes and edges of the network of routes being formed by route elements,
wherein each vehicle, represented as an entity in a distributed ledger system, enters into transaction agreements with the route elements, likewise represented as entities in said distributed ledger system,
wherein each transaction agreement of a vehicle with a route element comprises at least one time specification defining the period of time for which the route element is occupied by the vehicle, and
wherein the route elements belong to a path necessary for a run of the vehicle.

7. The method for scheduling or controlling the movements of a plurality of vehicles over a network of routes according to claim 6, wherein each transaction agreement of a vehicle with a route element comprises a further transaction criterion which designates a fee to be paid for the occupancy of the route element by the vehicle.

8. The method for scheduling or controlling the movements of a plurality of vehicles over a network of routes according to claim 6, wherein the distributed ledger system is configured as a blockchain.

9. The method for scheduling or controlling the movements of a plurality of vehicles over a network of routes according to claim 6, wherein the method comprises at least one transaction agreement of a first vehicle with a second vehicle concerning the exchange or release of a route element occupied by the first vehicle during a defined period of time.

10. The method for scheduling or controlling the movements of a plurality of vehicles over a network of routes according to claim 9, wherein the transaction agreement of a first vehicle with a second vehicle concerning the exchange or release of a route element occupied by the first vehicle during a defined period of time contains a further transaction criterion designating a fee to be paid by the second vehicle for the exchange or release of the route element.

11. The method for scheduling or controlling the movements of a plurality of vehicles over a network of routes according to claim 7, wherein the distributed ledger system is configured as a blockchain.

12. The method for scheduling or controlling the movements of a plurality of vehicles over a network of routes according to claim 7, wherein the method comprises at least one transaction agreement of a first vehicle with a second vehicle concerning the exchange or release of a route element occupied by the first vehicle during a defined period of time.

13. The method for scheduling or controlling the movements of a plurality of vehicles over a network of routes according to claim 8, wherein the method comprises at least one transaction agreement of a first vehicle with a second vehicle concerning the exchange or release of a route element occupied by the first vehicle during a defined period of time.
